(19) United States
(12) Patent Application Publication
(10) Pub. No.: US 2004/0226418 A1
(43) Pub. Date: Nov. 18, 2004

(54) Flexible drive wrench handle

(76) Inventor: Henry Herbert Honniball, San Francisco, CA (US)

Correspondence Address: HENRY H. HONNIBALL, 89 MARIETTA DR., SAN FRANCISCO, CA, 94127, US

(21) Appl. No.: 10/430,237

(22) Filed: May 6, 2003

(51) Int. Cl. B25B 23/16

(52) U.S. Cl. 81/177.7

(57) ABSTRACT

A flexible drive wrench handle comprising of numerous steel links. Each link has a slotted cavity with rounded ends 2 at one end, at the other end of the link is a stud with rounded end 3, this stud 3 is inserted into the slotted cavity of the next link to form a friction fit and connected together by means of a tight fitting removable mushroom head pin 4.

Numerous links are thus connected together to form a flexible drive wrench handle of the desired length. Additional steel links may be added to increase the flexible drive wrench handle, thus providing additional torque, or links removed to shorten the flexible drive wrench handle.

To the last link of the flexible drive wrench handle is connected a link with an open end wrench head, or a close end wrench head or a link with the square stud that will accept a drive socket to form a tool for removing or replacing threaded fasteners such as nuts, bolts, hex head bolts and other fasteners.

The tool may be provided with several types and sizes of wrench heads and drive sockets, both standard and meteric.

### CROSS-REFERENCE TO RELATED APPLICATIONS

Not Applicable

### SEQUENCE LISTING OF PROGRAM

Not Applicable

### BACKGROUND OF THE INVENTION

1. Field of Invention

This invention relates specifically to flexible drive wrench handles.

2. Background of Invention

Mechanics and others who use tools for repairing automobiles or other equipment too often find that the handles for the drive sockets, open end, and close end wrenches are rigid and are not flexible enough to access certain recessed areas or confined spaces in their work.

A search of the prior art has located designs of various ratchets and bent handles to try to solve this problem.

Examples of such prior art are U.S. Pat. Nos. 4,592,254; 1,306,533; 2,733,745 and 4,099,430.

The above mentioned tools do not provide the adaptability for use in recessed or confined spaces.

This invention provides improvement on the existing rigid wrench handles and makes the flexible drive wrench handle more versatile that the open or close end wrenches, and combination wrenches or drive socket wrenches that are available in the market place.

### SUMMARY OF OBJECTS OF THE INVENTION

The flexible drive wrench handle consists of numerous steel links connected together to form a chain which is made semi-flexible to form a flexible drive wrench handle.

Each of the chain links are held together by tight fitting removable mushroom head steel pins through the holes at each end of the links, thus allowing the links to flex around each pin.

Each chain link is flexed along its connecting link to fit the contour for accessibility of a recessed and difficult to access areas where machine bolts or nuts or other fasteners are located.

When torque or force is applied parallel with the connecting pins in either direction, the flexible drive wrench handle operates as a wrench and moves clockwise or counter clockwise in the direction of the torque that is manually applied for the installation or removal of fasteners.

One end of each link consists of a flat stud with rounded end and a hole through its center, the other end of the link consists of a slotted cavity through which the stud of the previous link is inserted into with a tight fit. The slotted cavity also has a hole through its center, so that the hole in the stud lines up with said hole of the slotted cavity, through which the tight fitting removable mushroom head steel pin is inserted to hold the links together.

Thus the flexible drive wrench handle may be lenghtened by the addition of links to provide additional torque, or shortened by-the removal of a number of the links.

In place of a flat stud at the end of the link, the stud is converted into an open end wrench head or close end wrench head or a ratchet or a square stud with a spring loaded button to which may be attached a drive socket or crowfoot wrench or a torx wrench head.

Either of the said converted links is attached to the stud of the last link of the flexible drive wrench handle with the removable mushroom head steel pinto form a flexible drive wrench.

Further advantages will become apparent for a consideration when reviewing the description of the drawings.

In addition to the flexible drive wrench handle that comprises of numerous steel links as described in the foregoing, a similar flexible drive wrench handle comprising of regular chain links as is used in motorcycles or the like may also be utilized.

### DRAWINGS

Drawing 01 shows a flexible drive wrench handle with a knurled handle with numerous tightly fitted steel links connected together and an open end wrench at the other end.

Drawing 02 shows a flexible drive wrench without a knurled handle, but numerous tightly fitted steel links connected together an a square steel stud at the end of the flexible drive wrench.

Drawing 03 shows a flexible drive wrench with a knurled handle with numerous tightly fitted steel links connected together and a square steel stud at the other end.

Drawing 04 shows an enlarged partial view of 2 steel links tightly connected together.

### DRAWINGS

### Reference Numerals

1 Knurled handle

2 Slotted cavity

3 Stud with rounded end

4 Mushroom head steel pin

5 Square steel stud

6 Spring loaded button

7 Open wrench head

### DETAILED DESCRIPTION: PREFERRED EMBODIMENT

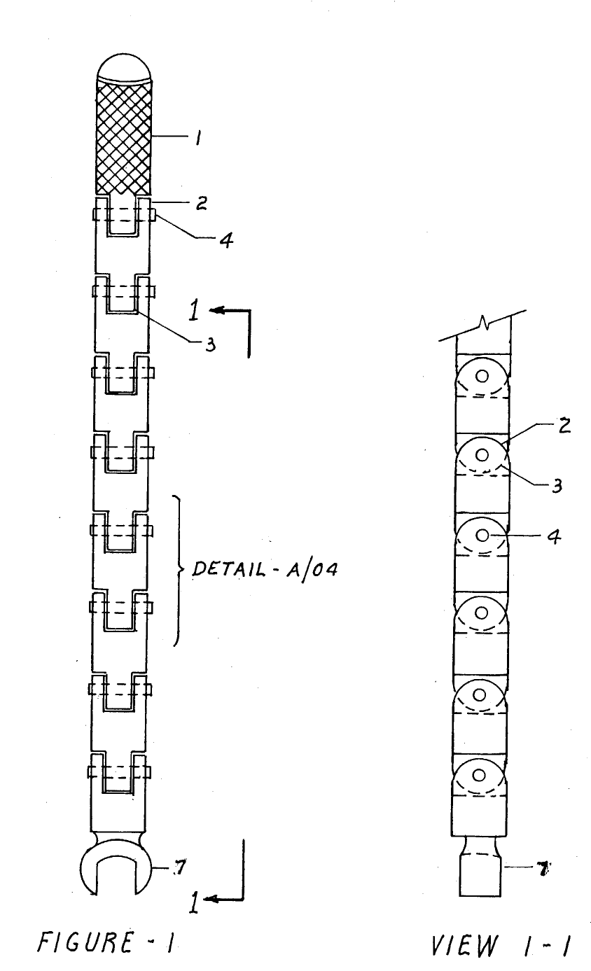

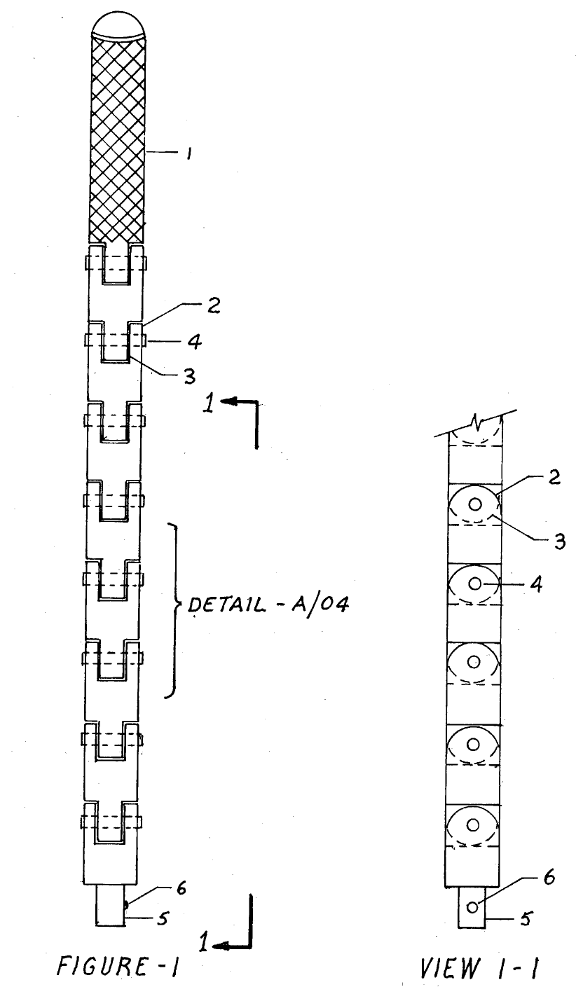

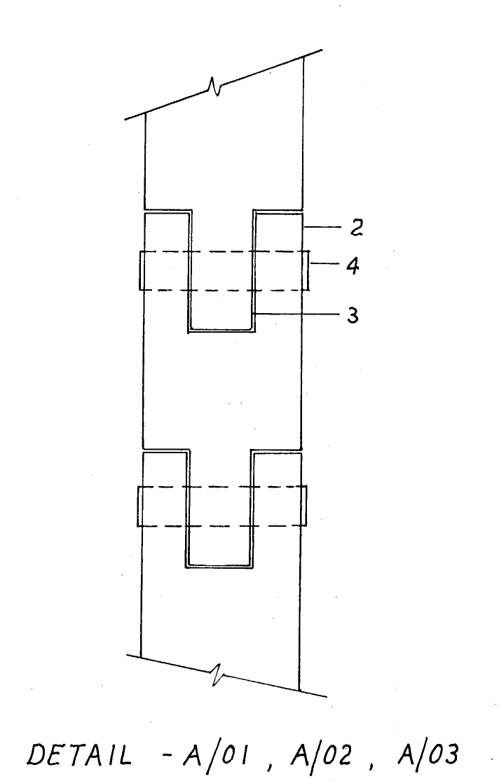

FIG. 1 of Drawing 01 show a knurled handle 1 tightly connected to a steel link 2 through a slotted cavity, by means of a tight fitting removal mushroom head steel pin 4.

At the other end of the steel link is a stud 3 with rounded end which is inserted into the slotted cavity 2 of the next steel link. Numerous links are thus tightly connected together to form any desirable length of a flexible drive wrench. The links are all tightly fitted together.

The last steel link is an open end wrench 7 which is connected to the last stud of the flexible drive wrench by a mushroom head steel pin 4.

VIEW 1-1 of Drawing 01 shows the side view of FIG. 1. In it is shown the steel links with the slotted cavity 2 with rounded ends, through

I claim:

1. A flexible drive wrench handle comprising of a series of steel links of predetermined length, connected together for applying torque to a fastener.

2. One end of each of said link of claim 1 comprises of a slotted cavity with rounded ends and a hole through the center of said slotted cavity. The other end of said link comprises of a stud with rounded end and a hole through the center of said stud.

3. Said link with the stud of claim 2 is inserted into the slotted cavity of the next link to form a tight fit.

4. Said links of claim 3 are connected together by means of tightly fitting removable mushroom head steel pins inserted in each of said holes in said links.

5. This procedure is continued until a predetermined number of said links are connected together.

6. Said links of claim 5 can be added to form a longer flexible drive wrench handle to provide additional torque or said links can be removed to form a shorter flexible drive wrench handle.

7. Said links of claim 6 can flex perpendicular with each of said pin, but will not flex when torque is applied parallel to each pin, thus converting said flex links into a flexible drive wrench handle.

8. The said links of claim 2 instead of having a stud at the end is converted into said link with a predetermined cast open end wrench head or a close end wrench head or a predetermined square stud which will accept a predetermined drive socket.

9. The said links of claim 8 can be attached to the end of the last said link with the stud of claim 6 with said mushroom head steel pin of said flexible drive wrench handle of claim 1 to form a tool with a truly flexible drive wrench.

10. A high quality drive chain of predetermined length and size as used in motor cycles, as an alternate flexible drive wrench handle with said predetermined open end wrench head or a close end wrench head or a predetermined square stud which will accept a predetermined drive socket of claim 8.
